(19) United States
(12) Patent Application Publication
(10) Pub. No.: US 2008/0193778 A1
(43) Pub. Date: Aug. 14, 2008

(54) Isolation Material

(75) Inventors: Cemil Bakir, Tekirdag (TR); Ibrahim Halil Yilmaz, Tekirdag (TR)

Correspondence Address: AKERMAN SENTERFITT, P.O. BOX 3188, WEST PALM BEACH, FL, 33402-3188, US

(73) Assignee: Izomaks Yalitim Ve Endustri Sanayi Ticaret Anonim Sirketi, Tekirdag (TR)

(21) Appl. No.: 11/965,412

(22) Filed: Dec. 27, 2007

(30) Foreign Application Priority Data
Feb. 8, 2007 (TR) 2007/00721
Aug. 28, 2007 (TR) 2007/05951

(51) Int. Cl. B32B 11/00; B05D 3/12; B05D 1/18; B32B 11/10; B05D 1/38; B32B 5/16

(52) U.S. Cl. 428/440; 427/365; 428/489; 428/468

(57) ABSTRACT

The invention relates to an isolation material, which is applied on the structures and surfaces where it is desired to provide isolation, in order to prevent the possible deformation by protecting said structures and surfaces against external factors, said isolation material being produced to extend the lifetime of the isolation by using the liquid, moisture and vapor impermeability feature of the plastic-derived material constituting the intermediate layer (2), and to obtain the possibility of rapid, easy and economic application and use for the bitumen (asphalt) (4) coated using the fibrous material (3). Said isolation material (1) is not easy to burn, is not affected by the temperature differences and is not influenced for a very long time by the factors such as sun, rain, snow, naturally occurring chemicals, plant roots, direct contact with the soil and time; hence it enables the isolation to last for long years.

### TECHNICAL FIELD

The invention relates to the isolation and covering materials used under the cold climate conditions for isolation purposes in the terrace roofs of the buildings, terrace roofs without the ability to walk around, inclined concrete roofs, domed and vaulted roofs, face coverings, chimneys, under the roofing tiles, the foundation retaining walls, for the water, vapor and moisture isolation in the wet places, balconies, flower gardens, gardens, water reservoirs, ponds, wastewater treatment plants, parking lots, hidden stream isolations, prefabricated buildings with dilatation, eaves troughs, insides of the small concrete canals, in the pressurized groundwater problems, highways, structures such as bridge and viaduct.

The invention relates in particular to the isolation and covering material, which is applied on the surface desired to be isolated, is used on said surface to provide water, vapor and moisture isolation, prevents black spots and plaster and paint blistering formed as a result of condensation on the interior surface of the wall or the roof, prevents the hot-cold temperature differences, is not affected by the factors such as sun, rain, snow, icing expected to cause deformation in the material, is not easy to burn, increases the strength, flexibility and durability term of the material and is easily applied on the ground to provide savings in time and labor.

### STATE OF THE ART

Today, many isolation materials are available, which are made of different materials with varying size and properties, and are suitable for many structures and surfaces. Among these, the best known products aimed at water isolation are the isolation materials, in the middle part of which are used the carrier materials like polyester felt, fiberglass and kraft paper, said isolation materials being produced by dipping in hot bitumen and coating and being called membrane. This material called membrane is characterized by scattering colored mineral quartz stones on one surface thereof. This material is influenced by the factors including sun, rain, snow, icing, heat differences, naturally occurring chemicals, plant roots, direct contact with soil, time, and thus becomes deformed and broken. Deformation of the isolation leads also to the deformation of the surface or area wished to be protected (foundation, wall, terrace, roof, highway etc.) and subsequently causes considerable damages and a shortening in their lifetime.

The carrier materials (polyester felt, fiberglass, kraft paper) used in the existing products have no capability of isolation. The aim of the carrier is to shape the reinforced bitumen in different thicknesses. The principal material that provides the isolation in such membranes is the reinforced bitumen that covers the carrier. Based on its nature, the bitumen alone has no resistance to external factors. In the buildings, such factors cause the mildewing and deformation in the walls that are covered with condensation and in the concrete screens that contact soil. This mildewing and deformation affect the health of the individuals, reduce the strength of the structure, as well as causing all the investments made for isolation to go for nothing and extra expenses to form after a while. Disruption of the water isolation leads to the formation of moisture, mildew and humidity at the interiors of the buildings, blistering of the plaster and the paint, leakage and seepage in the roofs and terraces, leaks in the water canals and sinks in the highways and viaducts.

According to the state of the art, in the patent document no. EP0116301 titled “Connective bed for building and bridge isolations”, the invention relates to an isolation material, which, when necessary, may completely be adhered to the multilayer bitumen canals with polymer variable owing to the soft fiberglass beds and the reinforced structure of the plastic layer by means of the plastic layer insulation paths and by placing these in bituminous or asphalt structures or between the bituminous layer and the hot layer for the bridge isolations.

There is provided a synthetic layer connecting bed comprising a multilayer and polymer-modified bituminous bed and the fiberglass-based reinforcing undercoat bonded with the retaining layer surrounding the whole surface and laid in soft PVC. The connective bed is fabricated by adhering the soft PVC and the saturated glass wool pillow to the bitumen bed. It is applied as follows: The bituminous undercoat is applied on a substructure made of concrete, and the connective bed is coated on this undercoat using the heat by means of welding process such that bitumen bed surface will cover the whole surface. Then according to the customary method, the first layer of the poured asphalt having a process temperature of up to 250° is spread on the synthetic surface of the connective bed and then the coating layer is applied. When the connective bed is being laid on the bitumen undercoat, these are preferably applied in a manner engaged to each other and the seams are fixed by means of welding.

As seen in this invention, the merging of said isolation element is carried out in the form of layers. In other words, it is not a one-piece product, thus it has a rather difficult assembly and a short useful lifetime.

Again at the present, in the patent document no. EP0396316 titled “Laminated Waterproof Material”, the invention relates to a tool and the manufacturing method for the same. According to this invention, a thin but strong plastic film is used in the middle layer as the waterproof material and there is a high number of holes on the film. The film is resistant to the advance of the cracks and serves as a barrier against the advance of the cracks between the adjacent asphalt layers to provide a superior protection for asphalt components. Asphalt layers are connected to each other through the holes on the polyester supporting layer. As an alternative to the coating, asphalt may be pressed or laminated onto PET film. Also, an asphalt layer may be applied to only one side of said film. Further, the production method according to the invention comprises the process steps of:
(a) Laying the plastic film of the desired length bearing a high number of holes,
(b) applying the molten asphalt on both surfaces of the laid plastic film,
(c) compressing the plastic film, on both surfaces of which the molten asphalt has been applied, such that the asphalt is forced to pass between the holes on said polyester film, in order to provide the joint of both asphalt layers in a way to form an integrity and
(d) cooling down said waterproof material. Said isolation material comprises a perforated plastic layer in its middle section and the mention is being made of laying said plastic layer and applying asphalt on the same. Combination of plastic and asphalt layers is a process with no endurance. The adherence of the asphalt material to the plastic takes place at a quite low performance. As will be understood from this information, the strength and the lifetime of the isolation material according to the invention is rather low. After a certain period of use, asphalt layer dries and starts to disintegrate due to the temperature differences. Since its adherence is weak, the separation from the plastic layer occurs. Consequently, the isolation feature of the material disappears.

Also the use of the perforated middle layers is described in U.S. Pat. No. 4,565,724, wherein the fiberglass is used as the material with holes at intervals of 50-110 mm (2-4.3 inch), the open area corresponding to 8-14% of the lateral area of the fiberglass base. The material is designed to be used for the construction of a roof in place, rather than being used in the previously made roof covering materials as in the present invention. During the preferred on-site construction phase, a blowpipe may be used to melt the uppermost modified asphalt layer. Said layer will afterwards pass through the holes on the fiberglass base to be fused onto the lower layer and the other layers. Such products are called the button based plate or the breathing plate. As will be understood from the inventive information, this invention is either unable to be used as a one-piece product, and it may be applied at the interior of the building in the form of layers during the construction stage. Because of the need for a device to melt the asphalt in order to apply the same to the perforated middle layer and of the related application method, it is a difficult process far from being practical.

Consequently, the presence of the need for an isolation element to protect the surfaces against the external factors and thus to prevent any possible deformation and the inadequacy of the existing products have made it necessary to make a product in the relevant art, which will not be affected by the aforesaid factors, will maintain the isolation feature for a much longer time and will be easily used.

### OBJECT OF THE INVENTION

In order to eliminate the drawbacks involved in the state of the art, the primary object of the invention is to provide the liquid, moisture and vapor isolation, which has a long useful lifetime, exhibits continuity, is the same at every point of the cross-section, is able to adapt to any surface and also is strong, durable and flexible.

Another object of the invention is to increase the strength of the structure and the surface and to extend the lifetime, owing to the prevention of the structural and surface deformation.

Another object of the invention is to provide increased structural and surface strength such that no maintenance and repair are needed and the modification costs are reduced as much as possible.

Another object of the invention is to provide the elimination of the unhealthy ambient conditions such as the mildew and moisture likely to form inside the building, owing to the liquid isolation provided.

Another object of the invention is to eliminate, owing to maximum protection provided, the risks of deformation, water penetration into the concrete, corrosion of the metal elements and the loss of structural resistance, and thus the disadvantages of the strength loss and the low resistance of the building in hazards of earthquake, landslide etc., as a result of the liquid leakage likely to form within the structure.

Another object of the invention is to eliminate the influence of the natural factors such as sun, rain, snow, icing, temperature differences, naturally occurring chemicals, plant roots and direct contact with soil and thus to enable the isolation to last for long years, by utilizing maximum liquid, moisture and vapor isolation feature.

Still another object of the invention is to provide that the isolation is not breakable and adapts to any surface, owing to its flexible structure.

Still another object of the invention is to minimize the maintenance and modification expenses for the highways by preventing all the deformations and the sinks owing to the maximum isolation provided to the highways and viaducts with a strong and durable structure of isolation.

Still another object of the invention is to provide the possibility for rapid, easy and economic application and use.

### DESCRIPTION OF THE FIGURES

FIG. 1a: Sectional view of the carrier layer of the isolation material according to the invention.

FIG. 1b: Sectional view of the layers of the isolation material according to the invention (the view with the lower and upper surfaces coated with polyethylene film).

FIG. 1c: Sectional view of the isolation material according to the invention, with stone covered on the upper layer thereof.

FIG. 2: The production scheme for the isolation material with both sides coated with polyethylene.

FIG. 3: The production scheme for the isolation material with one side coated with polyethylene and the other side coated with mineral.

### REFERENCE NUMBERS

1—Isolation material
2—Plastic-derived intermediate layer
3—Material with fibers and filaments (felt, flannel, leg, non-woven
4—Bitumen (asphalt)
5—Aluminum folio, mineral, slate or quartz stone
6—Polyethylene film
T—Carrier layer
T¹—Bituminous cover
H—Bitumen coating tank
S—Cylinders
E—Extruder
B—Felt Bobbin

### DETAILED DESCRIPTION OF THE INVENTION

The invention relates to an isolation material (1) applied to the structure or the surface where it is desired to provide isolation, in order to prevent the possible deformation in said structures or surfaces by protecting the same against the external factors.

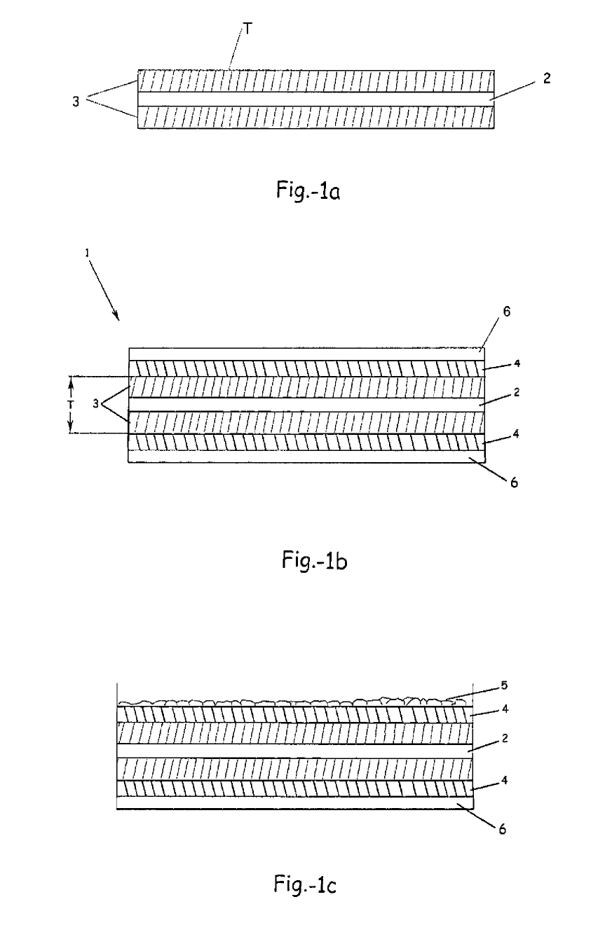

In FIG. 1a, the carrier layer (T) is seen, which is obtained by integrating the material with fibers (3) onto both surfaces of a plastic-derived intermediate layer (2). One and most preferred production method for said carrier layer (T) is to pour the plastic in hot state between the two materials with fibers (3). In the following, said method will be explained in detail.

In FIG. 1b, the sectional view is provided for the layers (2, 3, 4, 5, T) of the isolation material (1) according to the invention. Said isolation material (1) comprises the plastic-derived intermediate layer (2), the material with fiber and filament (felt, flannel, leg, non-woven) (3) coated on both surfaces, carrier layer (T), bitumen (asphalt) (4) coated on both surfaces of the carrier layer (T) and the polyethylene film (6) layer coated on the outward-facing surface of said bitumen layers.

The isolation material (1) shown in FIG. 1c comprises, contrary to the one in FIG. 1b, aluminum folio, mineral, slate or quartz stone (5) optionally coated on one surface instead of polyethylene film (6) and the polyethylene film (6) on the other surface coated to prevent adhesion when wrapped into a roll.

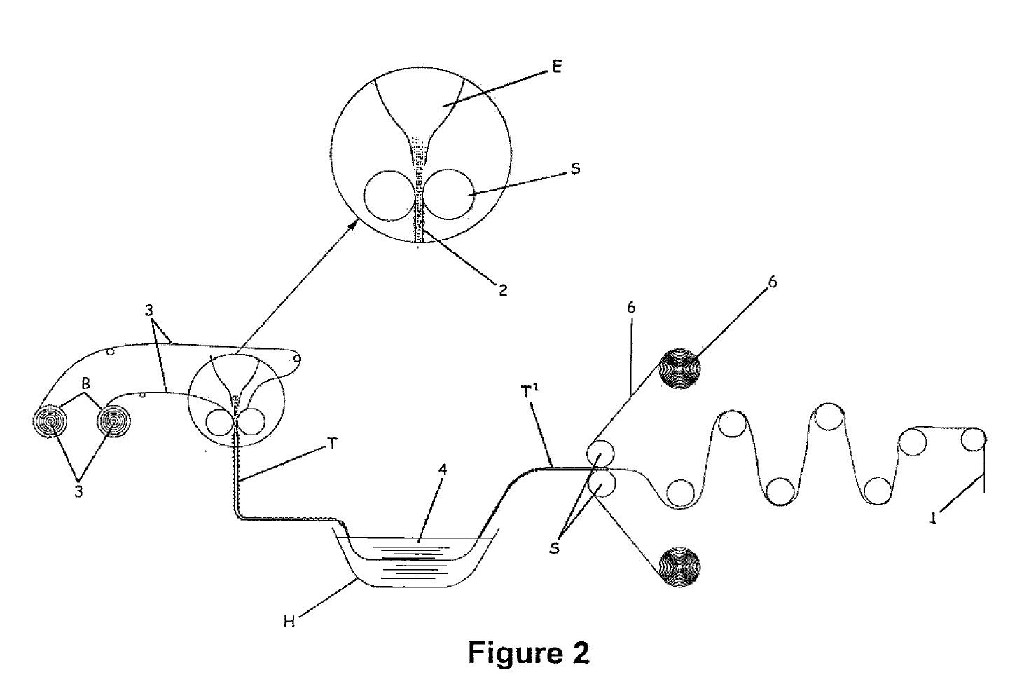

In the production of said isolation material (1), the following process steps are applied as shown in FIG. 2:
Melting in the extruder (E) the raw material of the plastic-derived intermediate layer (2) obtained from plastic and derivates thereof,
pouring the plastic (2) in molten state in between the two separate fibrous felts (3) arriving between the cylinders (S) from two separate bobbins (B), in order to bring the plastic (2) into film state,
passing the same through the cylinders (S) along with the felt (3),
coating both surfaces of the plastic film (2) with felt (3), in order to form the surface for the bitumen (4) to adhere and to obtain the carrier layer (T) in the form of panel, film or plate with desired width and thickness.

Since the plastic-derived intermediate layer (2) used as the principal isolation material (1) according to the invention has a smooth surface, it is difficult for the bitumen (4) material to adhere onto the same. Therefore, a fibrous surface is formed by using the felt (3), in order to enable the plastic-derived intermediate layer (2) to be coated with bitumen (asphalt) (4).

For said felt (3), any one of the materials with fiber and filament (flannel, leg, non-woven) may be used. Instead of said material, the component referred to as felt (3) may also be any material enabling the asphalt to adhere onto the plastic material. According to the invention, the reason for the preference of the felt is that it is a very easy to access and an inexpensive to procure material. However, here the felt is not a component having a limiting effect on the scope. An isolation material obtained by the use of different components achieving the same purpose will remain the protective scope of this patent.

Again, as seen in FIG. 2, thus obtained carrier layer (T) is dipped into the hot and preferably reinforced bitumen (asphalt) (4) inside the coating tank (H), and is passed between the cylinders (S), in order to convert the same into the bituminous cover (T¹) having desired thickness. As will seen in the same figure, both surfaces of the obtained bituminous cover (T¹) are coated with polyethylene film (6) to obtain the isolation material (1). The sectional view of the final product obtained is provided in FIG. 1b.

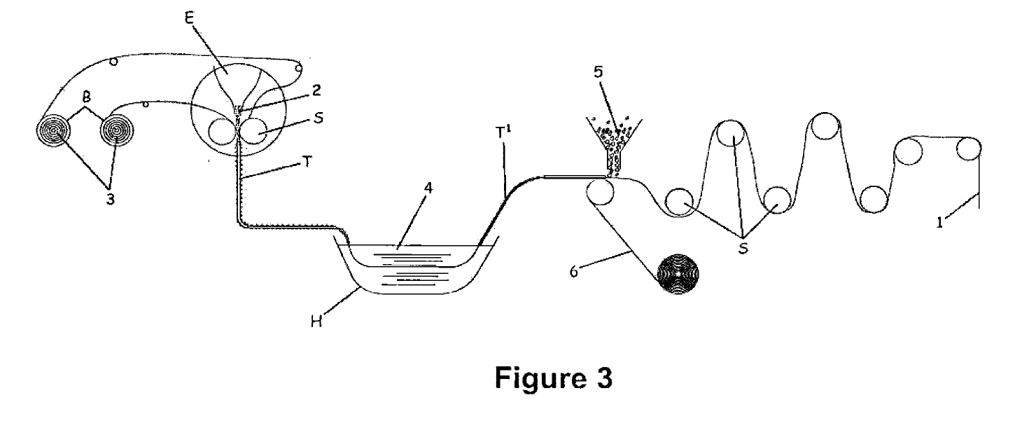

As seen in FIG. 3, if desired, the isolation material (1) is obtained being characterized in that one surface of the hot bituminous cover (T¹) coming out of the asphalt coating tank (H) is coated with aluminum folio, mineral, slate or quartz stone (5), while the other surface is coated with polyethylene film (6). The sectional view of the final product obtained with this process is provided in FIG. 1c.

An embodiment of the application may be described as follows, without having a limiting effect on the protective scope thereof:

The final isolation materials (1) whose sections are provided in FIG. 1b and 1c may be put on the market after being brought into roll form. Polyethylene film (6) layers are used, in order to prevent the adherence of the bitumen (4) in roll form and to provide portability and easy assembly. The product obtained in roll form may be applied on the desired surface of application according to the methods known in the prior art. Different from the prior art, the present invention may be applied on not only the horizontal surfaces but also the vertical surfaces, owing to said carrier layer's (T) capability to carry the bitumen (4) layers in a healthy manner. After the isolation material (1) according to the present invention is applied, it does not undergo deformation even after long years. The reason for this is as follows: The outermost bitumen (4) layer being in continuous contact with the external ambience may be likely to start conducting water due to its being cracked, broken or other reasons resulting from the external factors. In such a case, the bituminous (4) isolation materials (1) used according to the prior art loose their validity and become insufficient with regards the isolation. However, according to the present invention, after said bitumen (4) has lost its isolation characteristic, the isolation continues owing to the carrier layer (T) in the center where there is present the plastic-derived intermediate layer (2), the isolation function may be maintained for long years without being affected by the ambient factors, unless exposed to a disturbing physical contact.

The protective scope of this application is determined in the section of claims and the scope may by no means be limited to the description above provided only for exemplary purposes. It is obvious that a person skilled in the art may provide the innovation put forward by the invention also by using the similar embodiments and/or apply this embodiment to other fields with similar purpose used in the relevant art. Consequently, such embodiments would obviously lack the criterion of innovative step.

1- A method for the production of an isolation material applied on a structure or surface in order to prevent the possible deformation by protecting said structure or surface against external factors, said isolation material comprising at least one bitumen layer and at least one intermediate layer in connection with said bitumen layer obtained from raw material formed of plastic and the derivatives thereof,
the method comprising the steps of:
pouring said plastic-derived material in molten form between the fibrous materials; and
obtaining the carrier layer by passing the same along with the fibrous materials between the cylinders.

2- A method according to claim 1, wherein PVC is used as said intermediate layer.

3- A method according to claim 1, wherein said fibrous material is a material formed from one or several of the felt, flannel, felt and non-woven materials, these being the materials with fiber and filament.

4- A method according to claim 1, wherein the carrier layer is obtained in the form of panel, film or plate with desired width and thickness from the formed surface, in order to enable the adherence of the bitumen (asphalt).

5- A method according to claim 1, wherein the carrier layer is dipped into hot and reinforced bitumen (asphalt) inside a coating tank and it is coated in desired thickness, by being passed between cylinders.

6- A method according to claim 1, wherein the isolation material is obtained by coating both surfaces of the obtained material with polyethylene film.

7- A method according to claim 1, wherein the isolation material is obtained by coating one surface of the obtained material with aluminum folio, mineral, slate or quartz stone and the other surface with polyethylene film.

8- An isolation material applied on a structure or surface in order to prevent the possible deformation by protecting said structure or surface against external factors, said isolation material comprising:
raw material obtained from plastic or the derivatives thereof to form an intermediate layer between a bitumen layer; and
a carrier layer obtained by combining said intermediate layer upon placement of the same between the fibrous materials.

9- An isolation material according to claim 8, further comprising a bituminous cover obtained by dipping said carrier layer into hot and reinforced bitumen (asphalt) inside a coating tank and coating it in desired thickness, by being passed between cylinders.

10- An isolation material according to claim 9, further comprising a polyethylene film with which both surfaces of the obtained material is coated to prevent the adherence and to make it conveyable when brought into roll form.

11- An isolation material according to claim 9, comprising a layer formed from aluminum folio, mineral, slate or quartz stone coated on the surface of the obtained material in contact with the exterior ambience.
